(19) United States
(12) Patent Application Publication
(10) Pub. No.: US 2011/0002144 A1
(43) Pub. Date: Jan. 6, 2011

(54) INTEGRATED OPTICAL SHEET AND OPTICAL DEVICE HAVING THE SAME

(75) Inventors: Jeong Ho PARK, Seoul (KR); Young Il KIM, Yongin-si (KR); Jun Won AN, Cheongju-si (KR); Myoung NAM GUNG, Anyang-si (KR); Dong Cheol LEE, Incheon (KR); Dae Sik SHIN, Seoul (KR)

Correspondence Address: HOLME ROBERTS & OWEN LLP, 1700 LINCOLN STREET, SUITE 4100, DENVER, CO, 80203, US

(73) Assignee: LMS CO., LTD, Gunpo-si (KR)

(21) Appl. No.: 12/625,868

(22) Filed: Nov. 25, 2009

(30) Foreign Application Priority Data
Jul. 1, 2009 (KR) 10-2009-0059925

(51) Int. Cl. F21V 8/00; G02B 5/02

(52) U.S. Cl. 362/620; 359/599

(57) ABSTRACT

Provided are an integrated optical sheet and an optical device having the same, and more particularly, an integrated optical sheet and an optical device having the same, in which a diffuser film and a prism film are integrated in a thin structure. The optical sheet includes a light collector including a plurality of prism elements extending in a first direction, and an anisotropic diffuser including a plurality of optical elements extending from a surface of the light collector opposite to the surface having the prism elements in a second direction different from the first direction. One part including downward prism elements and scattering elements is formed at one surface and the other part including diffusion elements is formed at the other surface to integrate a conventional diffusion film to a horizontal prism film, providing a thin optical sheet.

### CROSS-REFERENCE TO RELATED APPLICATION

This application claims the benefit under 35 U.S.C. §119(a) of Korean Patent Application No. 10-2009-0059925, filed on Jul. 1, 2009, the disclosure of which is incorporated herein in its entirety by reference.

### BACKGROUND

1. Field

The present invention relates to an integrated optical sheet and an optical device having the same, and more particularly, an integrated optical sheet and an optical device having the same, in which a diffuser film and a prism film are integrated in a thin structure.

2. Description of the Related Art

Liquid crystal displays (LCDs) are widely used for information displays such as notebooks, personal computers, TVs, etc., and characteristics of the LCDs have improved year by year according to expansion of demands. A liquid crystal panel of the LCD is a non-emission device and thus requires a backlight unit due to its structure. The backlight unit is constituted by various optical systems. In addition, the backlight unit uses an optical sheet as an aggregate of optical films, which are periodically arranged, to improve luminance thereof.

FIG. 11 illustrates a structure of a conventional LCD. Referring to FIG. 11, problems of a conventional optical sheet will be described below. As shown in FIG. 11, the LCD 101 includes a backlight unit 20 and a liquid crystal panel 30. The backlight unit 20 includes a light source 21, a light guide plate 22, and an optical sheet including a diffuser film 24 and a prism film 10. Light emitted from the light source 21 is scattered through the light guide plate 22 to directly enter a user's eyes so that a pattern of the light guide plate 22 is projected as is. Since the pattern may be clearly detected even after mounting the liquid crystal panel 30, it is necessary to minimize the pattern using the diffuser film 24. However, after passing through the diffuser film 24, the light is diffused in horizontal and vertical directions to abruptly decrease luminance of the light. Therefore, the prism film 10 gathers the light again to increase the luminance of the light. The prism film 10 has mountain-shaped fine grooves, and is conventionally constituted by two sheets, one of which is vertically disposed adjacent to the light guide plate 22, and the other of which is horizontally disposed. As a result, the light passed through the prism film 10 has a collected viewing angle and is directed to a front surface, improving the luminance.

Since the conventional optical sheet includes a plurality of films 10 and 24 having different functions and its assembly process is thus complicated and requires careful attention, there are problems of decreasing productivity and competitive power due to a decrease in operation ability and yield.

In addition, use of the plurality of films increases of the entire thickness of the backlight unit and manufacturing cost, decreasing competitive power of end products such as LCDs.

### SUMMARY

The present invention provides an integrated optical sheet in which a plurality of films are integrated in a thin structure.

The present invention also provides an optical device capable of improving yield and implementing a compact structure by employing the integrated optical sheet.

According to an aspect of the present invention, there is provided an integrated optical sheet including a light collector including a plurality of prism elements extending in a first direction, and an anisotropic diffuser including a plurality of optical elements extending from a surface of the light collector opposite to the surface having the prism elements in a second direction different from the first direction. One part including downward prism elements and scattering elements is formed at one surface and the other part including diffusion elements is formed at the other surface to integrate a conventional diffusion film to a horizontal prism film, providing a thin optical sheet. A transparent base may be further disposed between the light collector and the anisotropic diffuser.

In addition, grooves may be formed between the prism elements of the light collector, and a plurality of scattering elements may be formed in the grooves.

Further, the anisotropic diffuser may include optical elements having major and minor axes, and formed of grooves or protrusions having heights that vary from the major axis to a circumference in the minor axis direction.

Furthermore, in the optical sheet in accordance with the present invention, the first direction may be perpendicular to the second direction. The downward prism element may be perpendicular to the anisotropic diffuser so that the light collected by the prism elements is diffused by the diffuser in a direction perpendicular to the collecting direction, increasing luminance of the light.

In addition, the height of the scattering elements may be equal to or smaller than ½ of the height of the downward prism elements. When the height of the scattering elements is larger than ½ of the height of the downward prism elements, since the scattering elements may interfere with the downward prism elements, the height of the scattering elements may be ½ or less of the height of the prism elements.

Further, the anisotropic diffuser may have the same direction of a minor axis of emission light distribution as the second direction, and a ratio of the major and minor axes of the emission light distribution may be 2:1 or more. On the distribution of light emitted by the anisotropic diffuser, when points, at which luminance values of 50% or more of the maximum luminance value are distributed, are connected, a substantially oval emission light distribution is obtained, and a direction of the minor axis of the oval shape is equal to the second direction. In particular, it is most preferable that a ratio of major and minor axes of the oval shape is 2:1 or more, which is derived from test, and detailed description thereof will be provided below.

Furthermore, the anisotropic diffuser may have a plurality of lenticules formed at an upper surface thereof, which may have a semi-spherical shape or a semi-cylindrical shape. In particular, a plurality of scattering elements may be formed between the lenticules. The scattering elements may be formed by a mold or roller having a sandpapered, blasted or scratched surface.

In addition, the lenticules may have an R value of 0.65 or less with respect to a pitch thereof, which is derived from test, and detailed description thereof will be provided below.

According to another aspect of the present invention, there is provided an optical device including: a light guide plate having an incidence surface at its side surface; an optical sheet including a light collector disposed on the light guide plate and a plurality of prism elements extending in a first direction, and an anisotropic diffuser having a plurality of optical elements extending from a surface of the light collector opposite to a surface having the prism elements in a second direction different from the first direction; and a prism sheet disposed on the optical sheet.

In addition, the first direction may be perpendicular to the second direction.

Further, the extension direction of the prism elements of the prism sheet may be perpendicular to the first direction, i.e., the extension direction of the downward prism elements.

Furthermore, the extension direction of the prism elements of the prism sheet may be the second direction.

In addition, the height of the plurality of scattering elements may be ½ or less of the height of the prism elements.

Further, the anisotropic diffuser may have the same direction of a minor axis of emission light distribution as the second direction, and a ratio of the major and minor axes of the emission light distribution may be 2:1 or more.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a schematic exploded perspective view of an LCD of an optical device in accordance with an exemplary embodiment of the present invention;

FIG. 2 is a detailed view of an optical sheet of FIG. 1;

FIG. 3A is a perspective view of an optical sheet in accordance with a first exemplary embodiment of the present invention as a view for explaining a lenticule of the optical sheet of FIG. 2, FIG. 3B is a perspective view of an optical sheet in accordance with a second exemplary embodiment of the present invention, and FIG. 3C is a perspective view of an optical sheet in accordance with a third exemplary embodiment of the present invention;

FIG. 4 is a view for explaining a difference depending on presence of a scattering element shown in FIG. 2;

FIG. 5 is a view for explaining variation in luminance depending on the height of the scattering element shown in FIG. 2;

FIG. 6 is a view for explaining the lenticule shown in FIG. 3B;

FIG. 7 is a view for explaining a change in luminance depending on variation in R value of the lenticule shown in FIG. 3B;

FIG. 8 is a view showing emission light from an anisotropic diffuser shown in FIGS. 2 and 3;

FIG. 9 is a distribution view of FIG. 8;

FIG. 10 is a view for explaining a lenticule in accordance with a third exemplary embodiment of the present invention; and

FIG. 11 is a schematic exploded perspective view of a conventional LCD.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

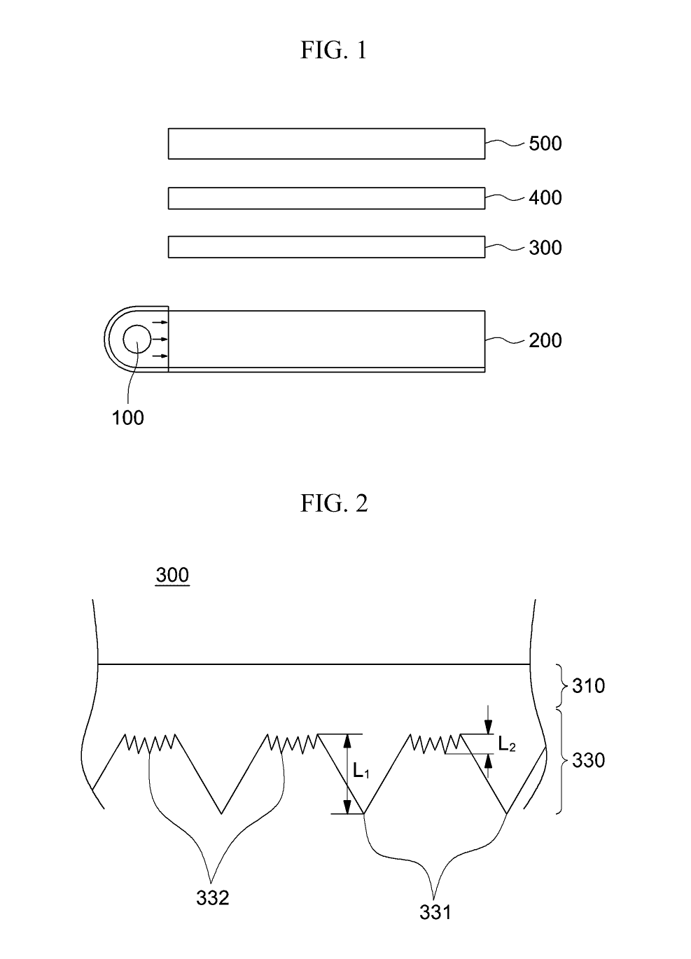

First, referring to FIG. 1, an LCD of an optical device in accordance with an exemplary embodiment of the present invention will be described.

The LCD includes a light source 100, and a light guide plate 200 installed at one side of the light source 100. The light guide plate 200 functions to guide the light incident from the light source 100 to emit the light. Therefore, a predetermined fine structure may be formed at a lower surface of the light guide plate 200 to reflect the light to a predetermined level. In addition, a reflection plate may be further installed at the lower surface of the light guide plate 200. While this embodiment illustrates the light source 100 installed at one side of the light guide plate 200, the light source may be installed in a vertical direction, not being limited thereto.

An integrated optical sheet 300 may be installed in an emission direction of the light guide plate 200, and a prism sheet 400 may be installed in an emission direction of the integrated optical sheet 300 to collect the light. In addition, a liquid crystal panel 500 may be formed in an emission direction of the prism sheet 400 to constitute one LCD.

As shown in FIG. 2, the integrated optical sheet 300 includes a light collector 330 having a plurality of downward prism elements 331 integrally formed with a surface of the optical sheet 300 toward the light wave guide 200 and extending in a width direction thereof and a plurality of scattering elements 332 formed between the prism elements 331, and an anisotropic diffuser 310 integrally formed with an emission surface to diffuse the light. As described above, the light collector 330 including the downward prism elements 331 and the scattering elements 332 are formed at one surface of the optical sheet 300, and the anisotropic diffuser 310 is formed at the other surface to diffuse the light collected through the collector 330, so that a conventional diffuser film is integrated with a horizontal prism film to implement a thinned optical sheet. A transparent base (not shown) may be further installed between the light collector 330 and the anisotropic diffuser 310. As a result, on the basis of the transparent base, the light collector may be installed at one surface of the base, and the anisotropic diffuser may be installed at the other surface.

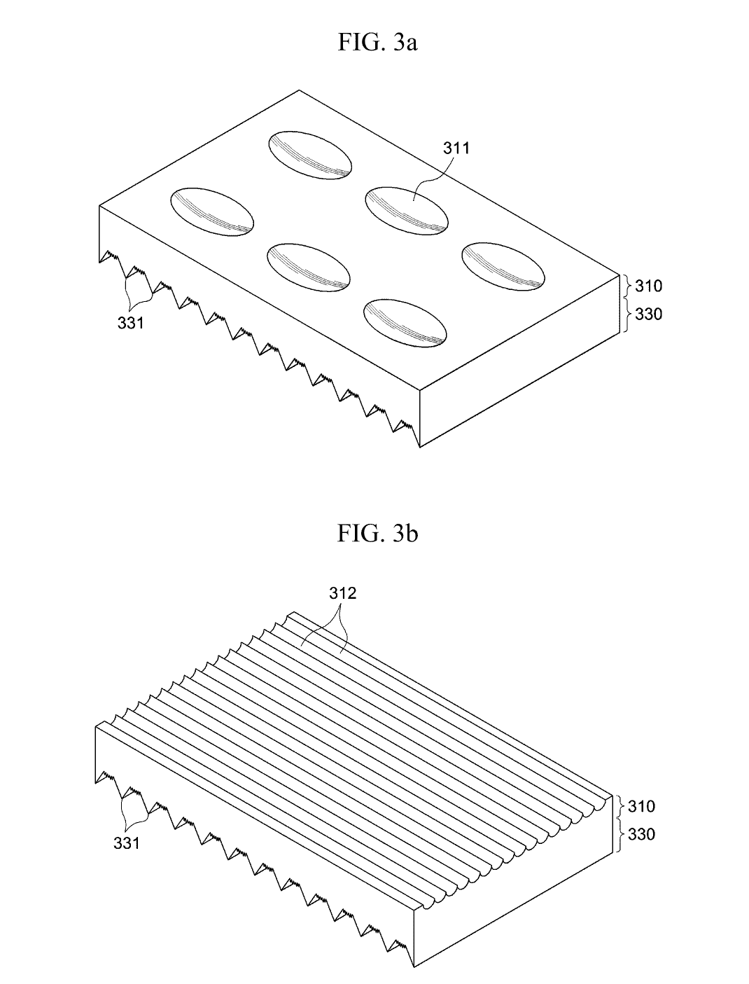

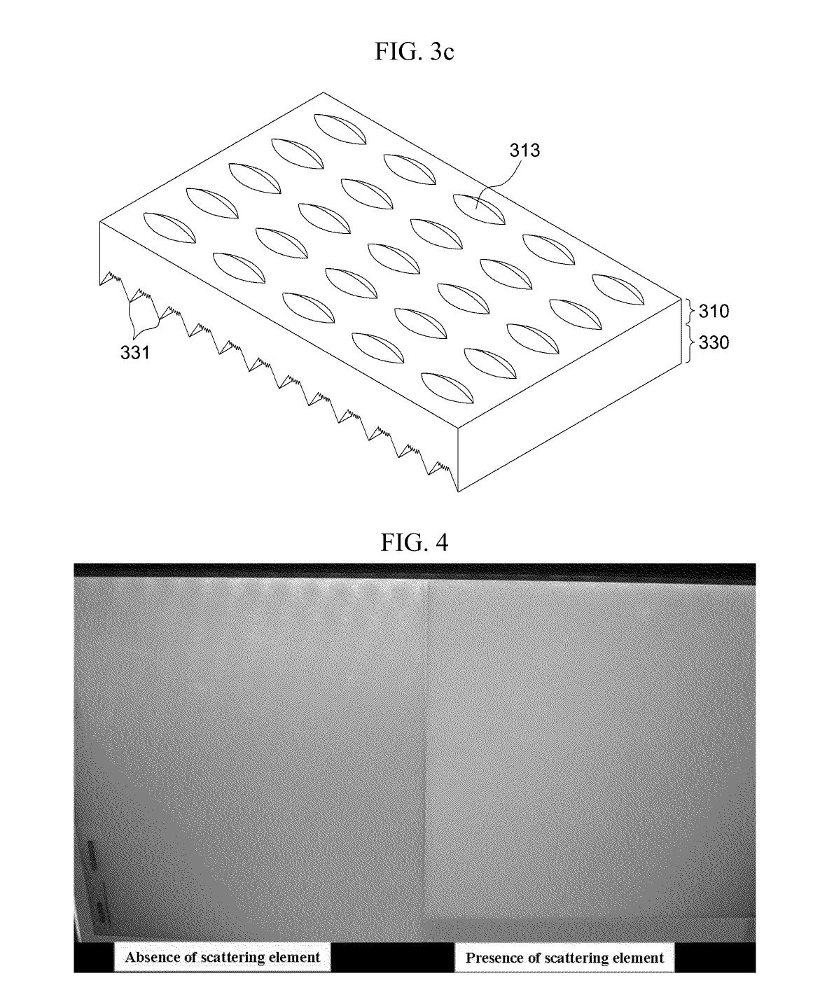

A plurality of lenticules may be formed as an optical element for diffusion at an upper surface of the anisotropic diffuser 310 in a longitudinal direction thereof. The lenticules may be formed in a semi-ellipsoidal shape 311 as shown in FIG. 3A, or may be formed in a semi-cylindrical shape 312 as shown in FIG. 3B.

Hereinafter, the lenticules having the semi-cylindrical shape 312 will be exemplarily described. While FIG. 3 illustrates engraved lenticules, since embossed lenticules may also have the same function, it will be appreciated that the present invention may include the engraved and embossed lenticules.

While the embodiment illustrates that the downward prism elements 331 of the light collector 330 are perpendicular to the lenticules 312 of the anisotropic diffuser 310, it is not limited thereto. That is, the downward prism elements 331 and the lenticules 312 may be formed to have a cross angle instead of a right angle.

Referring to FIG. 2, the scattering elements 332 are formed between the downward prism elements 331 of the light collector 300. Referring to FIG. 4, when there is no scattering element at a left side of the light source, while it is possible to accomplish high luminance using the light source or the prism element, irregularity in luminance may appear. In order to remove the irregularity in luminance, scattering elements are also installed at a right side of the light source to scatter the light. Therefore, if the appearance is not important and high luminance is needed, the scattering element 332 may not be installed. However, where irregularity in luminance should be excluded, it is necessary to install the scattering element 332.

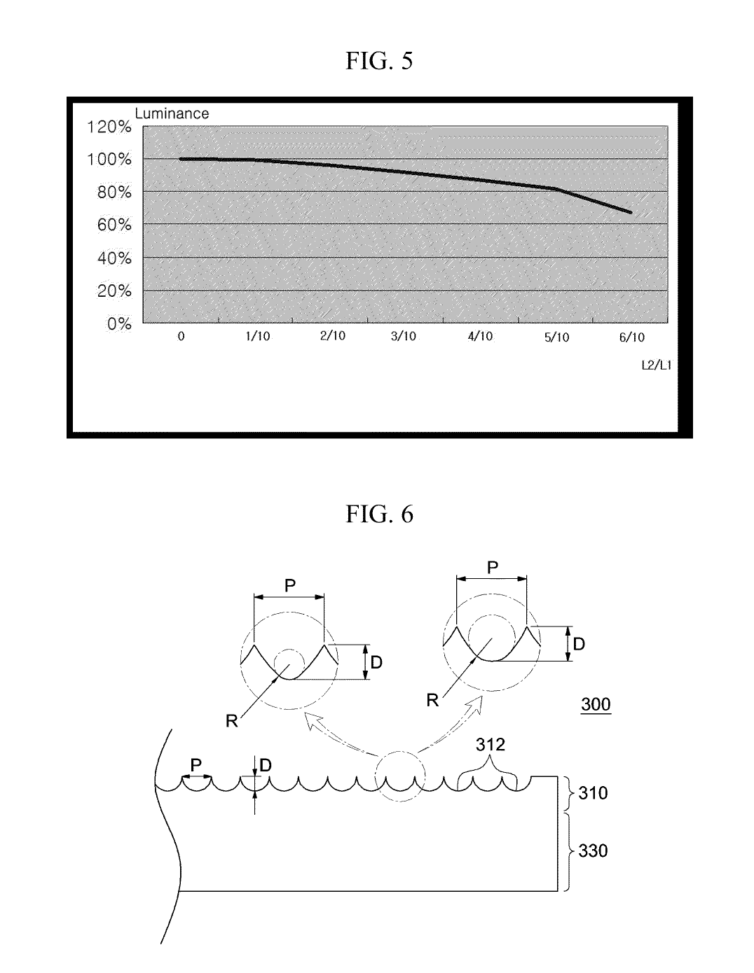

Here, a height L2 of the scattering elements 332 formed between the downward prism elements 331 of the light collector 330 may be equal to or smaller than a height L1 of the downward prism elements 331, preferably, equal to or smaller than ½ of the height Ll. When the height L2 of the scattering elements 332 is larger than ½ of the height L1, since the scattering elements 332 may interfere with the downward prism elements 331 to decrease scattering performance, it is preferable that the height L2 is equal to or smaller than ½ of the height L1. According to test results, as shown in FIG. 5, it will be appreciated that when the height L2 of the scattering elements 332 is equal to or smaller than ½ of the height L1, luminance gradually decreases, but when it is larger than ½ of the height L1, luminance abruptly decreases. In other words, in order to prevent overall decrease in luminance, it is most preferable that the height L2 of the scattering elements 332 is equal to or smaller than ½ of the height L1 of the downward prism elements 331.

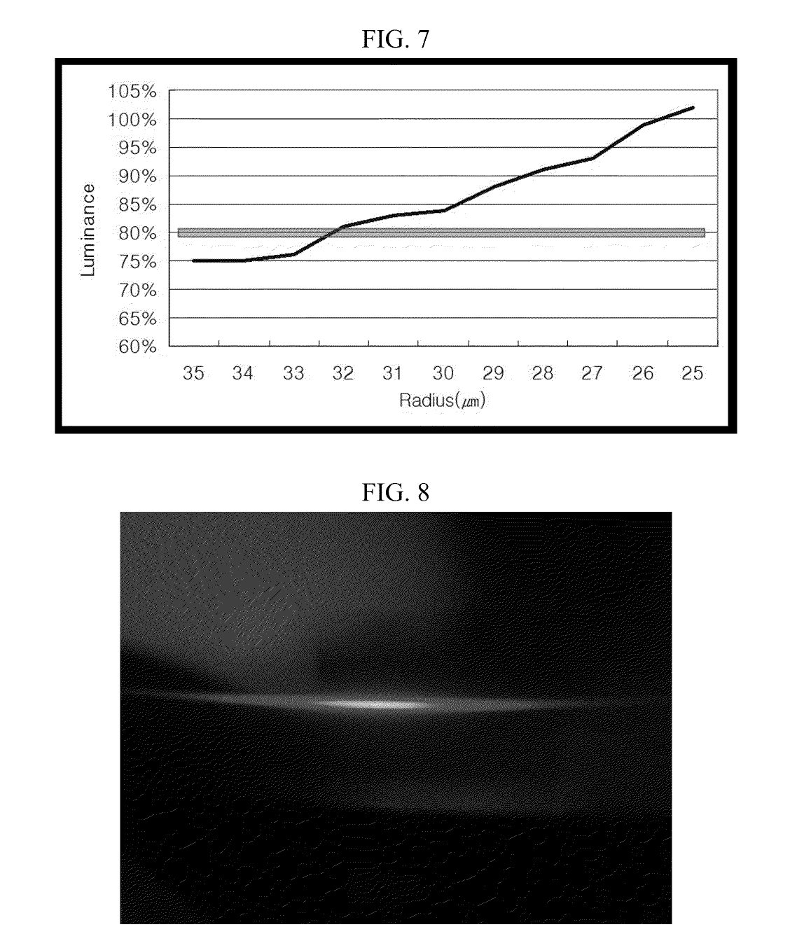

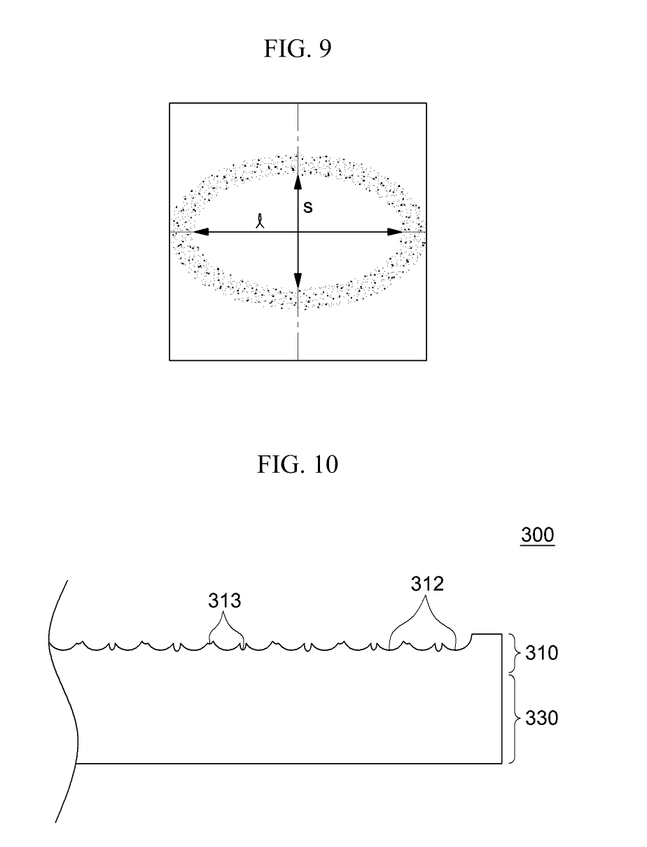

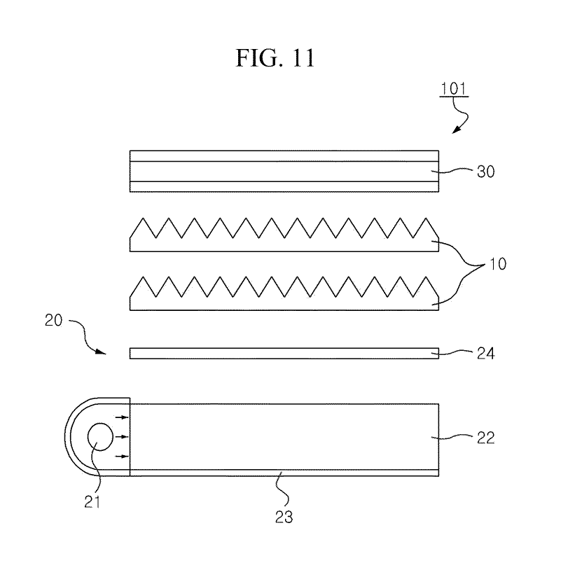

The lenticules 312 of the anisotropic diffuser 310 may have a semi-spherical shape or a semi-cylindrical shape so that a light diffusion amount can be adjusted by varying R values of the lenticules. FIG. 7 shows test results measured by varying the R values.

In FIG. 7, luminance values with respect to a reference luminance value of the integrated sheet 300 are represented as percentages by varying the R values in a state in which a pitch P is fixed to 50 μm and a depth D is fixed to 25 μm.

As shown in FIG. 7, it will be appreciated that the luminance value remarkably increases when the R value of the lenticule is a radius of 32 μm, and then, the luminance value gradually increases as the R value gradually decreases. In other words, it will be appreciated that a significant luminance improvement effect can be obtained when a ratio of the R value with respect to the pitch P is 0.65 or less.

While this embodiment illustrates the anisotropic diffuser formed by the lenticules, the anisotropic diffuser may have a leaf pattern or scratches to represent anisotropic characteristics. As shown in FIG. 3C, a leaf-shaped optical element 313 has an oval structure with a major axis and a minor axis. The oval structure is embossed such that the height of the over structure gradually decreases to both ends with respect to a center of the major axis, i.e., a circumference of the minor axis. While this embodiment illustrates the optical element having an embossed structure, the optical element may have an engraved structure, i.e., grooves. The leaf-shaped optical element 313 has a ratio of the major and minor axes within a range of 1.5:1 to 50:1. It is most preferable that the lengths of the major and minor axes are 1 to 5000 μm and 1 to 100 μm, respectively and the height of the optical element is 0.2 to 20 0 μm.

FIG. 8 shows emission light after separating only the anisotropic diffuser 310 of the integrated sheet 300. Provided that the luminance of incidence light is 100%, when points at which luminance values of 50% or more are distributed are connected, a substantially oval emission light distribution is obtained. Measuring ratios of the major and minor axes of the oval structure by varying R values of the lenticules 312 of the anisotropic diffuser 310, the following table 1 is obtained.

| R values | 35 | 34 | 33 | 32 | 31 | 30 | 29 | 28 | 27 | 26 | 25 |
|---|---|---|---|---|---|---|---|---|---|---|---|
| Ratio | 1.4:1 | 1.45:1 | 1.7:1 | 2.04:1 | 2.21:1 | 2.3:1 | 2.4:1 | 2.84:1 | 3:1 | 3.4:1 | 3.6:1 |

The above test is performed by a conventional viewing angle measuring apparatus, and emission light distribution obtained through the viewing angle measuring apparatus has an oval shape with a major axis and a minor axis. The minor axis is formed in an extension direction of the lenticule of the integrated sheet 300, and the major axis is formed perpendicular to the extension direction of the lenticule of the integrated sheet 300. In particular, when a ratio of the major axis and the minor axis of the anisotropic diffuser is equal to or larger than 2:1, luminance is remarkably improved. The ratio of the major and minor axes 2:1 corresponds to an R value 32 μm of the lenticule, and a ratio of the R value with respect to the pitch corresponds to 0.65. That is, when the lenticule has a ratio of the R value of the anisotropic diffuser with respect to the pitch of 0.65 or less, good luminance of a front surface can be obtained. Provided that the results are generalized to the anisotropic diffuser having no lenticule, i.e., the anisotropic diffuser made by forming the leaf pattern or one-directional scratches, when a ratio of the major and minor axes of the emission distribution is 2:1 or more, good luminance of a front surface can be obtained.

Meanwhile, scattering elements 313 may be further formed between the lenticules 312 of the anisotropic diffuser 310 as shown in FIG. 10. The scattering elements 313 function to prevent appearance of the irregularity in luminance as shown in FIG. 4. The scattering elements 313 as shown in FIG. 10 may be formed by a mold or roller having a sandpapered, blasted or scratched surface, which is well known to those skilled in the art, and thus, detailed description thereof will be omitted.

In the meantime, when the optical device is constituted by disposing the prism sheet on the optical sheet, the extension direction of the prism elements of the prism sheet may be disposed perpendicular to the extension direction of the downward prism elements, i.e., a first direction, or the minor axis direction of the anisotropic diffuser, i.e., a second direction.

As apparent from the above description, an integrated optical sheet in accordance with the present invention integrates a portion of an optical film to form a thin structure to enable high luminance and uniformity of the light emitted through the optical sheet.

In particular, an optical device employing the optical sheet can be implemented as the thin structure, and an assembly process can be reduced and yield can be improved to provide high competitive power to end products.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. An optical sheet comprising:
a light collector including a plurality of prism elements extending in a first direction; and
an anisotropic diffuser including a plurality of optical elements extending from a surface of the light collector opposite to the surface having the plurality of prism elements in a second direction different from the first direction.

2. The optical sheet according to claim 1, wherein grooves are formed between the plurality of prism elements of the light collector, and a plurality of scattering elements are formed in the grooves.

3. The optical sheet according to claim 1, wherein the first direction is perpendicular to the second direction.

4. The optical sheet according to claim 2, wherein a height of the plurality of scattering elements is equal to or smaller than ½ of a height of the plurality of prism elements.

5. The optical sheet according to claim 1, wherein the anisotropic diffuser has the same direction of a minor axis of an emission light distribution as the second direction, and a ratio of the major and minor axes of the emission light distribution is 2:1 or more.

6. The optical sheet according to claim 1, wherein the anisotropic diffuser has a plurality of lenticules formed at an emission surface thereof.

7. The optical sheet according to claim 1, wherein the anisotropic diffuser comprises optical elements having major and minor axes, and formed of grooves or protrusions having heights that vary from the major axis to a circumference in a minor axis direction.

8. The optical sheet according to claim 6, wherein the plurality of lenticules have an R value of 0.65 or less with respect to a pitch thereof.

9. The optical sheet according to claim 6, wherein the plurality of lenticules have a semi-spherical shape or a semi-cylindrical shape.

10. The optical sheet according to claim 6, wherein a plurality of scattering elements are formed between the plurality of lenticules.

11. The optical sheet according to claim 2, wherein the plurality of scattering elements is formed by a mold or roller having a sandpapered, blasted or scratched surface.

12. The optical sheet according to claim 1, further comprising a transparent base disposed between the light collector and the anisotropic diffuser.

13. An optical device comprising:
a light guide plate having an incidence surface at its side surface;
an optical sheet including a light collector disposed on the light guide plate and a plurality of prism elements extending in a first direction, and an anisotropic diffuser having a plurality of optical elements extending from a surface of the light collector opposite to a surface having the plurality of prism elements in a second direction different from the first direction; and
a prism sheet disposed on the optical sheet.

14. The optical device according to claim 13, wherein grooves are formed between the plurality of prism elements of the light collector, and a plurality of scattering elements are formed in the grooves.

15. The optical device according to claim 13, wherein the first direction is perpendicular to the second direction.

16. The optical device according to claim 13, wherein a extension direction of the plurality of prism elements of the prism sheet is perpendicular to the first direction.

17. The optical device according to claim 13, wherein a extension direction of the plurality of prism elements of the prism sheet is the second direction.

18. The optical device according to claim 14, wherein a height of the plurality of scattering elements is ½ or less of a height of the plurality of prism elements.

19. The optical device according to claim 13, wherein the anisotropic diffuser has the same direction of a minor axis of an emission light distribution as the second direction, and a ratio of the major and minor axes of the emission light distribution is 2:1 or more.
